(19) United States
(12) Patent Application Publication
(10) Pub. No.: US 2026/0242193 A1
(43) Pub. Date: Aug. 20, 2026

(54) MOUNT CHAIN ADJUSTMENT

(71) Applicant: Sellick Equipment Ltd., Harrow (CA)

(72) Inventors: Danny Lee Denney, Radford, VA (US); Michael George Cookson, Amherstburg (CA)

(21) Appl. No.: 19/543,278

(22) Filed: Feb. 18, 2026

Related U.S. Application Data
(60) Provisional application No. 63/759,836, filed on Feb. 18, 2025.

(51) Int. Cl. B66F 9/075; B60P 7/08

(52) U.S. Cl. CPC B66F 9/07504; B60P 7/0807

(57) ABSTRACT

In some embodiments, a system for mounting a forklift to a transport vehicle includes a chain assembly that is configured to extend between a first anchoring point of transport vehicle and a second anchoring point of the forklift. The second anchoring point is an anchor pin that extends from the forklift, and the chain assembly includes an adjustable plate that has a first aperture that receives the anchor pin of the forklift. The system further includes a bracket that couples with the adjustable plate and is configured to receive the anchor pin through an opening of the bracket. A retainment pin extends through a second aperture of the anchor pin, and the retainment pin can retain the adjustable plate around the anchor pin. The bracket is configured to retain the retainment pin through the second aperture.

### CROSS REFERENCE TO RELATED APPLICATIONS

The present application claims the benefit of and priority to U.S. application Ser. No. 63/759,836, filed on Feb. 18, 2025, which is incorporated herein by reference in its entirety.

### REFERENCE REGARDING FEDERALLY SPONSORED RESEARCH OR DEVELOPMENT

Not applicable.

### SEQUENCE LISTING

Not applicable.

### FIELD OF EMBODIMENTS OF THE DISCLOSURE

The present disclosure provides a system and method for mounting heavy machinery trucks or trailer, and more specifically, to a system including a chain adjustment plate and a retainer component.

### BACKGROUND

Truck-mounted forklifts are designed to travel with, and mount onto, delivery trucks or trailers, allowing operators to unload materials immediately upon arrival without relying on site equipment. Truck-mounted forklifts are secured using transport chains that attach between the forklift and an anchor point of a truck trailer. Proper mounting requires selecting appropriate chain length to adequately suspend the forklift over the road during travel. However, adjusting the chain length often requires secondary tools and excessive time, leading operators to skip adjustments during multi-truck operations or time-sensitive loading. When the chain length is not properly adjusted, the forklift may sag during transit, which can lead to tire wear, ground contact, or mechanical damage. Although quick-release devices such as lynch pins can reduce adjustment time, they may introduce reliability concerns, which includes vibration-induced loosening or increased susceptibility to tampering when the equipment is left in publicly accessible locations.

Accordingly, there is a need for a fastening solution that permits quick, tool-free adjustment of chain length while securely retaining a lynch pin or equivalent fastening pin within the receiver pin during adjustment, working, and travel conditions. Embodiments of the present disclosure address these issues by providing a bracket configured to couple to the adjustable plate and restrain the lynch pin.

### SUMMARY

Some embodiments of the invention provide a system for mounting a forklift to a transport vehicle. The transport vehicle includes a first anchoring point and the forklift includes a second anchoring point. The system includes a chain assembly that is configured to extend between a first anchoring point and a second anchoring point. The second anchoring point is an anchor pin that extends from the forklift, and the chain assembly includes an adjustable plate that has a first aperture that receives the anchor pin of the forklift. The system further includes a bracket that couples with the adjustable plate and is configured to receive the anchor pin through an opening of the bracket. A retainment pin extends through a second aperture of the anchor pin, and the retainment pin can retain the adjustable plate around the anchor pin. The bracket is configured to retain the retainment pin through the second aperture.

In some embodiments, the bracket is configured to allow for removal of the retainment pin when the chain assembly is in an adjustment position. In some embodiments, the bracket rotates about the anchor pin when the chain assembly is moved from the adjustment position to a travel position. In some embodiments, the first plurality of tabs is configured to retain the retainment pin when the chain assembly is in the travel position. In some embodiments, the bracket defines a body that includes a front face and a rear face opposite the front face, and the bracket includes a first plurality of tabs that extend from the body in a first direction. In some embodiments, the bracket includes a second plurality of tabs that extends from the body in a second direction. The first direction and the second direction are perpendicular with respect to the front face and the rear face. In some embodiments, the second plurality of tabs is configured to couple with the adjustable plate.

Some embodiments of the invention provide a bracket for retaining a retainment pin. The bracket includes a body that defines a front face, a rear face opposite the front face, and a central opening that is configured to receive an anchor pin therethrough. The bracket further includes a plurality of protruding tabs that includes a first tab that extends from a bottom side of the bracket in a first direction, a second tab that extends from a top side of the bracket in a second direction opposite the first direction, a third tab that extends from a top side of the bracket in the first direction, and a fourth tab that extends from a lateral side of the bracket in the first direction. The lateral side of the bracket is defined between the top side and the bottom side. The fourth tab is configured to retain a retainment pin that is configured to extend through an aperture of the anchor pin. The second tab is configured to be coupled with a plate that is configured to receive the anchor pin.

In some embodiments, the first tab is configured to retain the retainment pin, and the third tab is configured to retain the retainment pin. In some embodiments, the plurality of tabs further includes a fifth tab and a sixth tab, and the fifth tab and the sixth tab each extend from the bottom side of the bracket in the second direction. In some embodiments, the first tab is disposed between the fifth tab and the sixth tab. In some embodiments, the fifth tab and the sixth tab are each configured to be coupled with the plate. In some embodiments, the bracket is configured to allow for removal of the retainment pin when the plate is in a first position. In some embodiments, the fourth tab is configured to be disposed adjacent to a distal end of the retainment pin when the plate is in the first position, the second tab is configured to be disposed adjacent to a head of the retainment pin when the plate is in a second position, and the head of the retainment pin is configured to be disposed opposite the distal end.

Some embodiments of the invention provide a method for mounting a forklift to a transport vehicle. The method includes connecting a chain assembly between a first anchor point on the transport vehicle and a second anchor point on the forklift. The second anchor point being an anchor pin, and the chain assembly includes an adjustable plate having an aperture. The method includes configuring the aperture of the adjustable plate around the anchor pin. The adjustable plate is secured around the anchor pin with a retainment pin that extends through a distal end of the anchor pin. The method further includes configuring a bracket around the anchor pin. The bracket includes a first plurality of tabs that are each configured to be coupled with the adjustable plate, and the bracket includes a second plurality of tabs that are each configured to retain the retainment pin within the anchor pin when the chain assembly is in a travel configuration.

In some embodiments, the retainment pin is capable of being removed from the anchor pin when the chain assembly is in an adjustment configuration. In some embodiments, the bracket is disposed between the adjustable plate and the retainment pin. In some embodiments, the bracket and the adjustable plate are capable of being rotated about the anchor pin. In some embodiments, the first plurality of tabs extends from a body of the bracket in a first direction, and the second plurality of tabs extends from the body of the bracket in a second direction, opposite the first direction. In some embodiments, the bracket is a unitary member.

Other aspects of the systems and methods for mounting a forklift to a transport vehicle described herein, including features and advantages thereof, will become apparent to one of ordinary skill in the art upon examination of the figures and detailed description herein. Therefore, all such aspects of the systems and methods for mounting a forklift to a transport vehicle are intended to be included in the detailed description and this summary.

### DESCRIPTION OF THE DRAWINGS

FIG. 1 illustrates a top, front, and right isometric view of an embodiment of a transport chain;

FIG. 2 illustrates a top, front, and left isometric view of a receiver pin of a forklift for the transport chain of FIG. 1;

FIG. 3 illustrates a side view of a forklift, loaded onto a truck trailer and suspended at a height using the transport chain of FIG. 1;

FIG. 4 illustrates a second side view of the forklift, loaded onto the truck trailer and suspended at a different height using the transport chain of FIG. 1;

FIG. 5 illustrates a third side view of the forklift, loaded onto the truck trailer and suspended at yet another height using the transport chain of FIG. 1;

FIG. 6 illustrates a lynch pin that is configured to retain the receiver pin through an adjustable plate of the transport chain of FIG. 1;

FIG. 7 illustrates the lynch pin of FIG. 6, locking the adjustable plate to the receiver pin with the transport chain in a loosened state;

FIG. 8 illustrates the lynch pin of FIG. 6, locking the adjustable plate to the receiver pin with the transport chain in a tensioned state;

FIG. 9 illustrates a front, top, and left side isometric view of a retainer component for the transport chain;

FIG. 10 illustrated a rear, top, and left side isometric view of the retainer component of FIG. 9;

FIG. 11 illustrates the retainer component of FIG. 9, assembled on an adjustment plate of a transport chain of FIG. 10, shown in an adjustment position or configuration;

FIG. 12 illustrates the retainer component of FIG. 9, assembled on the adjustment plate of the transport chain of FIG. 10, shown in a working position or configuration;

FIG. 13 illustrates the retainer component of FIG. 9, assembled on the adjustment plate of the transport chain of FIG. 10, shown in a transport position or configuration;

FIG. 14 is a front elevational view of a plate that is configured to be formed into the retainer component of FIG. 9;

FIG. 15 is a top, front, and right side isometric view of the retainer component of FIG. 9;

FIG. 16 is a top, front, and left side isometric view of the retainer component of FIG. 9;

FIG. 17 is a top, rear, and right side isometric view of the of the retainer component of FIG. 9;

FIG. 18 is a top, rear, and left side isometric view of the retainer component of FIG. 9;

FIG. 19 is a front elevational view of the retainer component of FIG. 9;

FIG. 20 is rear elevation view of the retainer component of FIG. 9;

FIG. 21 is a right side elevational view of the retainer component of FIG. 9;

FIG. 22 is a left side elevational view of the retainer component of FIG. 9;

FIG. 23 is a top plan view of the retainer component of FIG. 9; and

FIG. 24 is a bottom plan view of the retainer component of FIG. 9.

### DETAILED DESCRIPTION

Before any embodiments are explained in detail, it is to be understood that the disclosure is not limited in application to the details of construction and the arrangement of components set forth in the following description or illustrated in the following drawings. The embodiments disclosed herein are capable of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Unless otherwise defined or limited, ordinal numbers are used herein for convenience of reference based generally on the order in which particular components are presented for the relevant part of the disclosure. In this regard, for example, designations such as “first”, “second”, etc., generally indicate only the order in which the relevant component is introduced for discussion and generally do not indicate or require a particular spatial arrangement, function, or structural primacy or order.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

The terms “about” and “approximately,” as used herein, refer to variations in the numerical quantity that may occur, for example, through typical measuring and manufacturing procedures; through inadvertent error in manufacturing processes; through differences in the manufacture, source, or materials used to make the articles of manufacture described herein; and the like. Throughout the disclosure, the terms “about” and “approximately” may refer to a range of values ±5% of the numeric value that the term precedes.

As used herein, unless otherwise specified or limited, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screws, other fasteners, or adhesive to hold separately formed pieces together, is an integral (and integrally formed) element. In contrast, an element formed from multiple pieces that are separately formed initially then later fastened together, is not an integral (or integrally formed) element.

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from the embodiments disclosed herein. Thus, embodiments of the disclosure are not intended to be limited to embodiments shown, but are to be accorded the widest scope consistent with the principles and features disclosed herein. The following detailed description is to be read with reference to the figures. The figures, which are not necessarily to scale, depict selected embodiments and are not intended to limit the scope of embodiments of the invention. Skilled artisans will recognize the examples provided herein have many useful alternatives and fall within the scope of embodiments of the disclosure.

As an initial matter, truck-mounted forklifts are a common type of portable forklift truck that assists with the delivery and distribution around trucks and trailers. Truck-mounted forklifts are designed to travel with, and mount onto, delivery trucks or trailers, allowing operators to unload materials immediately upon arrival without relying on site equipment. These forklifts typically detach from the rear of a truck or trailer, deploy stabilizers for balance, and hydraulic lift systems to handle pallets or any other heavy item or load. By providing on-site unloading capabilities, truck-mounted forklifts streamline logistics, improve delivery flexibility, and ensure materials can be placed exactly where they're necessary on a job site.

These truck-mounted forklifts mount onto the back of a truck or truck trailer by utilizing the hydraulic lift system to suspend the body of the vehicle off from the rear of the trailer. The truck or trailer contains two mounting pockets that are configured to receive the forks of the forklift. By inserting the forks into the mounting pocket of the trailer, the forklift can engage the hydraulic forks to descend toward the ground, thereby pressing the forks downward into the mounting pocket, and resultantly, lifting the entire body of the forklift above the ground. To further fasten the forklift to the rear of the trailer, a chain system is used to hold up the back end of a forklift during transit. Typically, a truck-mounted forklift contains anchor points in the form of receiver pins on each opposing side of the forklift cab. Correspondingly, the rear of a truck or truck trailer will contain a mounting bar on each side that is configured to receive a hook of the chain system. In this way, the chain system hooks between the mounting bar on the trailer and the receiver pin of the forklift. To ensure a secure connection, after the forklift is suspended above the ground, a chain system is attached on both sides of the forklift in a loosened state. Then, to fully tighten the chain system, the forklift body is lowered until each chain is supporting the weight of the forklift. In this way, the lowest point of the forklift is sufficiently suspended above the ground such that the forklift is safe from ground impact or scaping on a bottom surface of the forklift during travel.

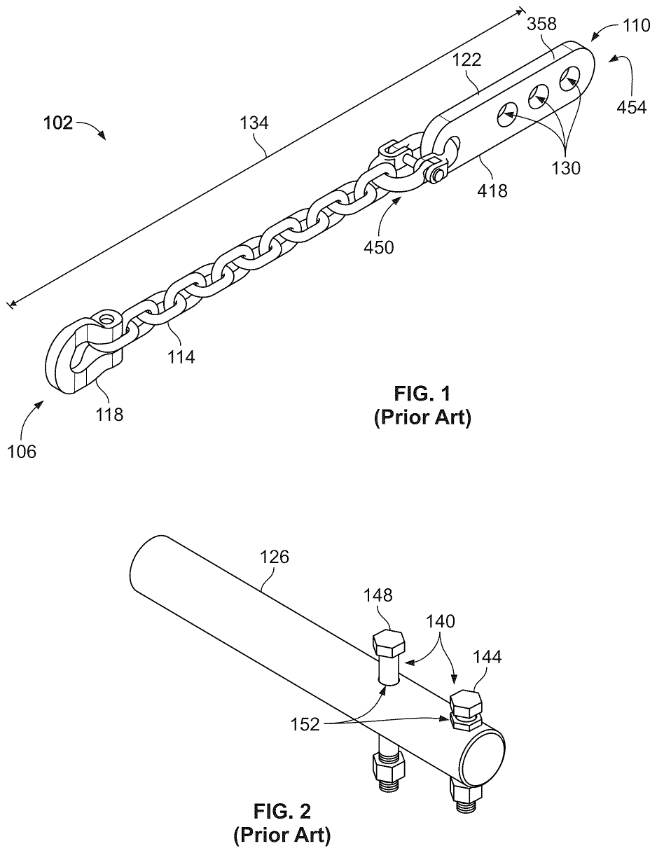

Referring now to FIGS. 1-8, various embodiments are shown for truck-mounting systems for a forklift. The truck mounting systems of FIGS. 1-8 utilizes various locking features between a chain and the forklift itself. In particular, FIG. 1 shows a standard transport chain 102 for truck-mounting system that is configured to mount a forklift to a rear end of a truck. As used herein, the term ‘truck’ generally refers to any truck, tractor-trailer, trailer, or comparable vehicle or vehicle component and is intended to encompass all such vehicles and equivalents thereof. The transport chain 102 defines a truck end 106 and a forklift end 110. A chain portion 114 extends between the truck end 106 and the forklift end 110, and is directly coupled to a shackle 118 positioned at the truck end 106 of the transport chain 102, the shackle 118 being configured to latch or hook onto an anchor point of a truck. Further, an adjustable plate 122 is disposed at the forklift end 110 of the transport chain 102, which is configured to receive a receiver pin 126 (see FIG. 2) i.e., an anchor point, of a forklift through an aperture of a plurality of apertures 130. The adjustable plate 122 has a “racetrack shape” body (i.e., a shape having two parallel sides and hemispherical ends) such that the plurality of apertures 130 extends successively along the center of the body of the adjustable plate 122. The plurality of apertures 130 is configured to provide the necessary adjustment to a length 134 of the transport chain 102, particularly, by allowing for the receiver pin 126 (see FIG. 2) of a forklift to receive any aperture of the plurality of apertures 130. For example, in cases where a shorter chain length 134 is necessary, an aperture of the adjustable plate 122 that is nearest the truck end 106 can be configured around the receiver pin 126.

Referring now to FIG. 2, the receiver pin 126 is shown having a locking mechanism. As discussed in connection with FIG. 1, the receiver pin 126 is configured to be an anchor point for a forklift and may include one of various types of locking mechanisms. Particularly, the receiver pin 126 includes a bolt locking mechanism 140. Although the receiver pin 126 is shown as a stand-alone component, the receiver pin 126 is typically directly mounted to the forklift, extending from opposing sides thereof to provide for level connection with the truck when the forklift is in a fully mounted configuration. Referring now FIGS. 1 and 2, the bolt locking mechanism 140 is configured to fully secure the adjustable plate 122 upon engagement of the receiver pin 126, as well as resist vibration-loosening effects caused during road travel of a truck. The bolt locking mechanism 140 includes a first bolt 144 and a second bolt 148. The first bolt 144 and the second bolt 148 are each configured to extend through a through hole 152 of the receiver pin 126. It should be noted that the through holes 152 of the receiver pin 126 extend entirely through the receiver pin 126 in a vertical direction (i.e., from a topmost point of the receiver pin 126 toward a ground surface). However, in other cases, only a single through hole 152 may extend through the receiver pin 126.

To fully secure the transport chain 102 to the receiver pin 126, an aperture of the plurality of apertures 130 of the adjustable plate 122 receives the receiver pin 126. The first bolt 144 and the second bolt 148 are positioned on opposing sides of the adjustable plate 122. Once the adjustable plate 122 is disposed between the first bolt 144 and the second bolt 148, vibration-resistant nuts can be tightened onto the bolts, thereby locking the adjustable plate 122 around the receiver pin 126.

When working on multi-truck operations, it's possible forklifts are moved from various trailers that may require different chain lengths to securely fasten a forklift to the rear of a trailer. In these instances, a wrench is required to manually adjust the length 134 of the transport chain 102, particularly, by unscrewing a nut and moving the adjustable plate 122 such that the receiver pin 126 receives a different aperture of the plurality of apertures 130. This adjustment requires additional time when loading the forklift that may inconvenience an operator or delay project delivery times. To avoid delay, it's common the transport chain 102 is not properly adjusted to accommodate the length required by different forklifts. In these cases, a rear end of a forklift may sag downward toward a road surface during transit as a result of turbulent driving conditions e.g., potholes, cracks, surface imperfections, etc. This may result in road wear on the forklift tires, machine damage, or broken parts thereof.

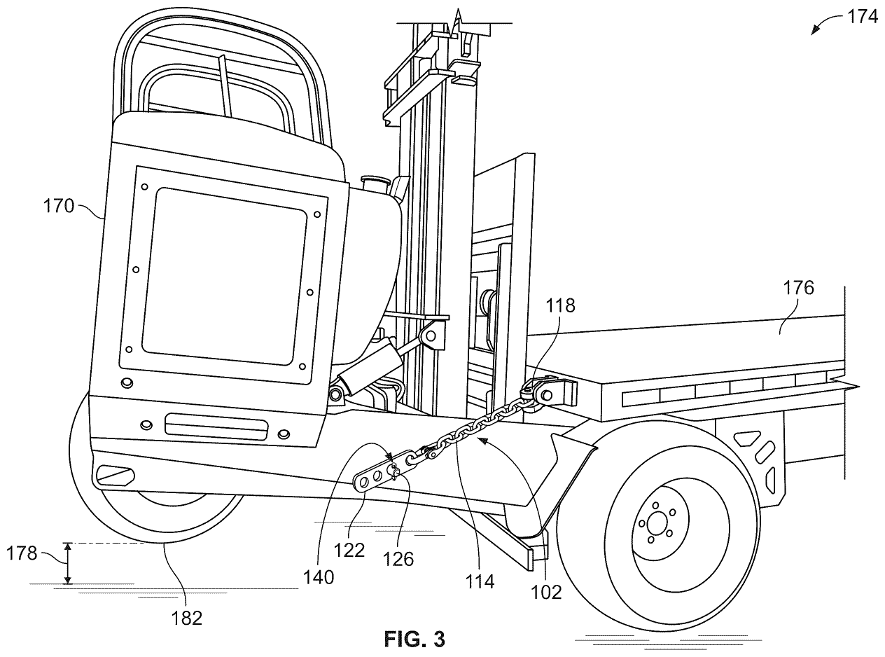

Referring now to FIG. 3, a forklift 170 is shown in a first mounted configuration 174 on the rear of a truck 176. In the first mounted configuration 174, the transport chain 102 is in a travel position, i.e., transport chain 102 connecting between the forklift 170 and the rear end of the truck 176 are in complete tension. In connection with above, the adjustable plate 122 of the transport chain 102 is locked around the receiver pin 126 using the bolt lock mechanism 140. Here, a height 178 is shown as the distance between a lowest point 182 of the forklift 170 and a ground surface. As illustrated, the first mounted configuration 174 represents an example of a safe and properly secured travel configuration for the forklift.

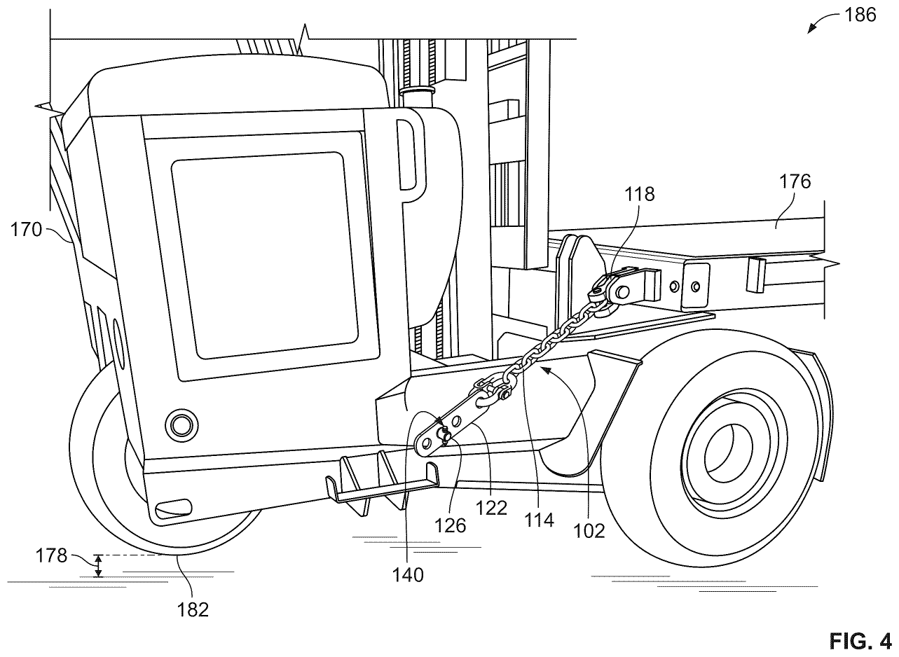

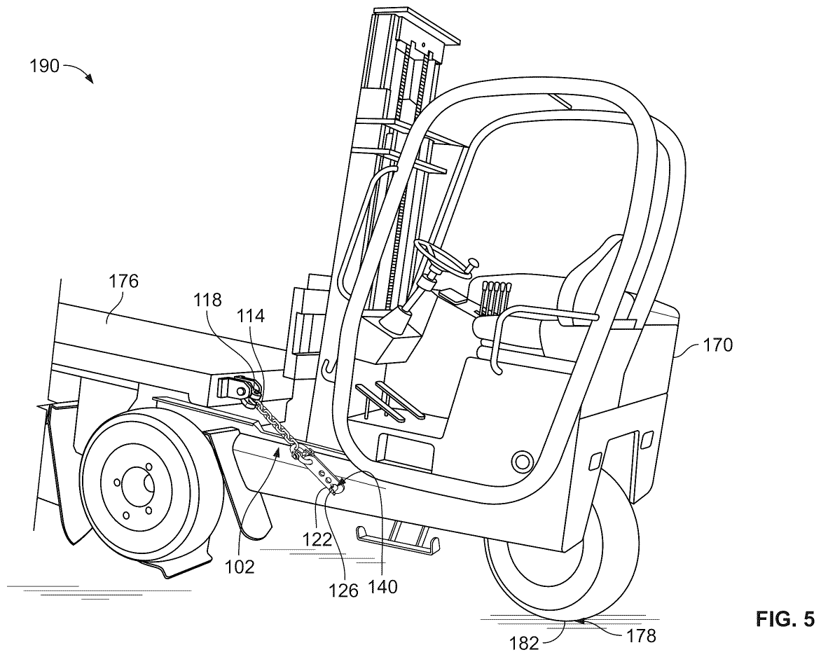

Referring now to FIG. 4, the forklift 170 is shown in a second mounted configuration 186 using the transport chain 102 with the bolt locking mechanism 140. As illustrated, the height 178 between the lowest point 182 and the ground surface is smaller in the second mounted configuration 186 as compared to the first mounted configuration 174 of FIG. 3. Although the forklift 170 remains suspended above the ground surface, the forklift 170 is more susceptible to damage or wear during road travel as a result of uneven driving conditions. The second mounted configuration 186 illustrates a condition in which the transport chain length 134 has not been properly adjusted when securing the forklift 170.

FIG. 5 shows a third mounted configuration 190 using the transport chain 102 with the bolt locking mechanism 140 such that the height 178 between the lowest point 182 and the ground surface is zero, i.e., the rear wheel of the forklift 170 is in contact with the ground surface. Similar to the second mounted configuration of FIG. 4, the third mounted configuration 190 is shown having an improper transport chain 102 length such the forklift 170 is susceptible to damage or wear during road travel. Such failures, as illustrated in FIGS. 4 and 5, typically result from operators not allocating sufficient time to disengage the bolt locking mechanism 140 to adjust the adjustable plate 122, or from the unavailability of appropriate tools at the worksite to remove the bolt locking mechanism 140.

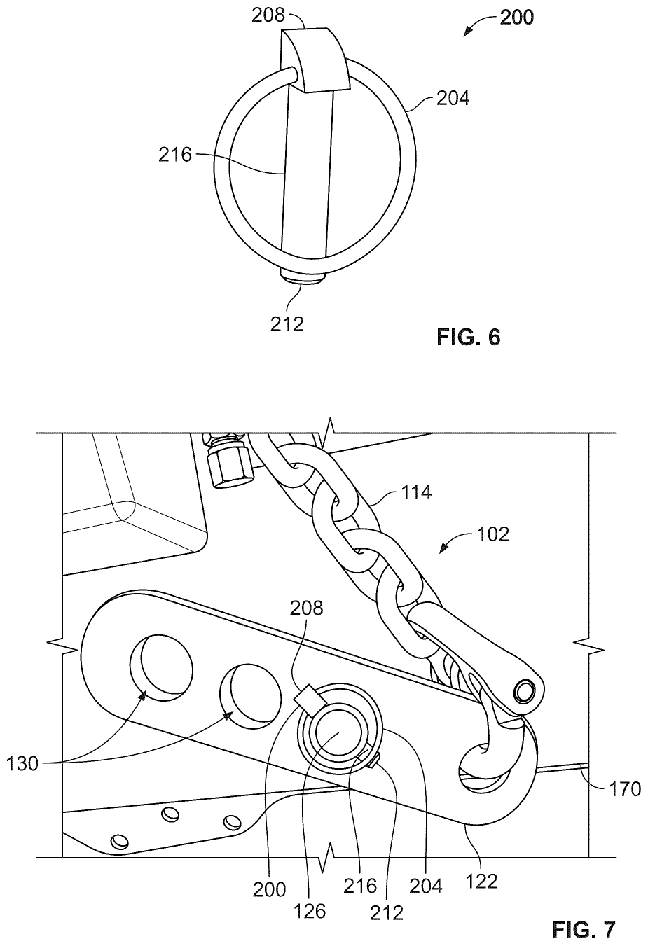

Referring now to FIGS. 6 and 7, a common alternative for the bolt locking mechanism 140 of FIGS. 2-5 is shown in the form of a locking pin or a lynch pin 200. The lynch pin 200 is utilized to retain the adjustable plate 122 in a manner similar to that of the bolt locking mechanism 140 of FIGS. 2-5. In particular, the lynch pin 200 extends through a distal portion of the receiver pin 126. However, the lynch pin 200 does not include a nut or vibration-resistant nut capable of locking the lynch pin 200 through the receiver pin 126. Instead, the lynch pin 200 includes a spring-based retaining ring 204 disposed on a head 208 of the lynch pin 200. The retaining ring 204 can pivot about the head 208 to secure a distal end 212 of the lynch pin 200 through the receiver pin 126. In a locked configuration, as shown particularly in FIG. 7, the retaining ring 204 circumscribes the receiver pin 126 such that a shaft 216 of the lynch pin 200 is secured within the receiver pin 126.

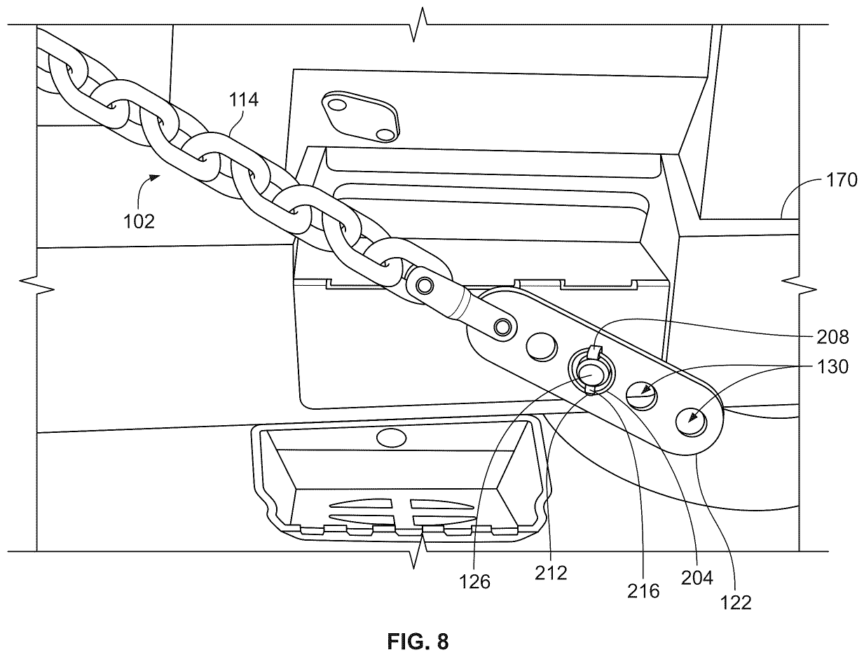

Referring now to FIG. 8, the transport chain 102 is shown again using the lynch pin 200 as the locking mechanism for the adjustable plate 122 and receiver pin 126. The lynch pin 200 can significantly reduce the amount of time necessary to adjust the length of the transport chain 102, particularly, since the retaining ring 204 can snap, or lock, entirely around the receiver pin 126, absent of any tools or hand tightening techniques. However, using the lynch pin 200 is not always the most reliable mechanism for securing the transport chain 102 to the receiver pin 126. In some instances, vibration and/or uneven driving terrain may cause incremental outward movement of the adjustable plate 122 along the receiver pin 126, and may additionally cause the retaining ring 204 to release/unlock. This movement may increase loading on the receiver pin 126, potentially causing mechanical failure or complete disconnection between the transport chain 102 and the receiver pin 126. In other instances, the retaining ring 204 can wear out and break apart from the lynch pin 200 such that the shaft 216 is not actively secured through the receiver pin 126. Further, the forklift 170, and/or associated machinery, are susceptible to theft when left in publicly accessible areas as a result of readily movable retaining ring 204 and lynch pin 200.

These deficiencies of conventional locking mechanisms for forklift transportation are particularly problematic for contexts in which various forklifts are required on job sites, and, for example, are moved between various trailers that require different chain lengths to fully secure the forklift. Lead times may be impacted from delayed delivery and/or shipment from a job site as a result of timely modifications to a transport chain length. In other circumstances, faster alternatives can increase the potential for equipment damage during travel as well as theft when left in public areas. Therefore, a readily removeable locking mechanism requires improved safety features for secure travel with truck-mounted machinery.

Embodiments of the present disclosure address one or more of the identified shortcomings, which are applicable to methods of securing heavy machinery in various worksite environments. For example, some embodiments of the present disclosure may be implemented for truck-mounted forklifts, however, alternative methods can be implemented with other truck-loaded machinery, such as telehandlers, skid-steer loaders, pallet loaders, mini excavators, compact track loaders, backhoe loaders, small bulldozers, trenchers, tractors, scissor lifts, or any other worksite machinery. Additionally, the present disclosure may also be implemented for securing additional truck-loaded equipment that is commonly transported to construction sites. Accordingly, the fastening mechanisms described herein may be adapted or configured to retain such equipment in a stable and secure manner throughout transit.

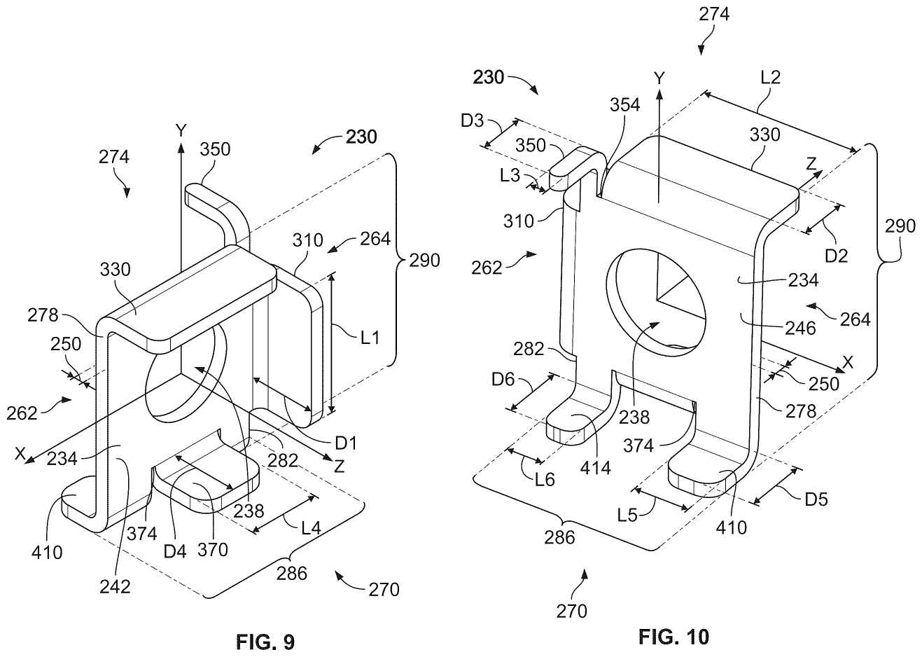

Referring now to FIG. 9, a bracket 230 for a locking mechanism is shown in an upright position. The bracket 230 is shown to be used on the right side of a forklift mount when connecting a transport chain. As will be discussed below, the bracket 230 is configured to fit onto a front surface of the adjustable plate 122 (see FIG. 1) such that the bracket 230 can also receive the receiver pin 126 (see FIG. 2) of a forklift and correspondingly retain, or “lock” a lynch pin within the receiver pin 126. The bracket 230 includes various flat extensions that help to secure itself over an adjustable plate such that the lynch pin 200 (see FIG. 6) can be locked through the receiver pin 126 (see FIG. 7). The bracket 230 includes a body 234 formed as an integral plate structure having a rectangular shape and that defines an opening 238. The body 234 includes a front face 242 and an opposing rear face 246 (see FIG. 10) such that the opening 238 extends entirely through the body 234, from the front face 242 to the rear face 246. Further, a thickness 250 is defined between the front face 242 and the rear face 246. The opening 238 has a generally circular shape and is configured to receive a cylindrical pin therethrough, however, in some embodiments, the opening 238 may take on any shape of a pin to which it receives. Further, in other embodiments, the opening 238 may have a similar circular shape with a different size diameter.

Still referring to FIG. 9, the bracket 230 defines a cartesian coordinate system having an X axis, a Y axis, and a Z axis with an origin of the coordinate system disposed at a central point of the opening 238, and offset on the front face 242 such that both the X axis and Y axis extend coincident to the front face 242. The Z axis is perpendicular to the front face 242 and the rear face 246 and extends centrally through the opening 238. A positive Z direction corresponds to a back-to-front face direction. The X axis is parallel to the front face 242 and the rear face 246 and extends horizontally between an open side 262 and a closed side 264 of the bracket 230. A positive X direction corresponds to a closed-to-open side direction. The Y axis is parallel to the front face 242 and the rear face 246 and extends vertically between a bottom side 270 and a top side 274 of the bracket 230. A positive Y direction corresponds to a bottom-to-top direction.

Still referring to FIG. 9, the open side 262 includes a first side surface 278 and the closed side 264 includes a second side surface 282, which are each defined by the thickness 250 of the plate structure. The first side surface 278 and the second side surface 282 bound opposing sides of the body 234 and extend in a vertical direction between the bottom side 270 to the top side 274 of the bracket 230. Further, the body 234 defines a horizontal width 286 between the open side 262 and the closed side 264, as well as a vertical height 290 between the bottom side 270 and the top side 274. In most cases, the width 286 and height 290 of the bracket 230 correspond to parameters of an adjustable plate to which it couples thereto, e.g., the height 290 being slightly greater than a corresponding height of an adjustable plate. In some embodiments, the width 286 and the height 290 are substantially equivalent. In other embodiments, the height 290 is greater than the width 286, or vice versa.

The bracket 230 further includes a side arm 310, which corresponds to the closed side 264 of bracket 230. The side arm 310 is integral with the body 234 and extends outward from the body 234 in a positive Z direction between the top side 274 and the bottom side 270 of the bracket 230 and along the second side surface 282. The side arm 310 is integral with the body 234, such that, for example, the side arm 310 is formed by inwardly bending a tab that projects from the body 234. A radial edge of the side arm 310 directs the side arm 310 from the body 234 toward the positive Z direction to define a rectangular shape. The side arm also defines a side arm depth D1, which is measured as the distance between the front face 242 and a distal end of the side arm 310. Further, a side arm length L1 defines the length of the arm in a Y direction. The side arm 310 is centered on the X axis and extends only a portion of the height 290 of the bracket 230. In some embodiments, the side arm 310 extends along the entire height 290. In other embodiments, the side arm 310 is offset from the X axis such that the side arm 310 is substantially above or below the X axis.

It should be appreciated that the bracket 230 illustrated in FIGS. 9 and 10 is depicted as a right-side bracket; however, as described below, a corresponding left-side bracket (not shown) includes substantially similar structural and functional features, but is inverted or reflected across the Y-axis. By incorporating a left-side and a right-side bracket 230, the orientation of each component thereof, relative to a truck and a forklift, remains consistent.

For purposes of the present disclosure, the terms “arm” and “leg” are used solely as orientation labels. As such, a “leg” or “legs” generally refers to structures disposed along a lower portion of a component, and an “arm” or “arms” refers to structures disposed along an upper portion. It should be understood, however, that the referenced arms and legs are each flange-like or tabular extensions that protrude outward from a body of the component, regardless of their descriptive terminology.

Referring now to FIG. 10, the bracket 230 includes a top arm 330 that is integral with the body and extends from the top side 274 of the body 234 in a positive Z direction. As will be discussed further below, the top arm 330 is configured to be adjacent and/or abut the head 208 of the lynch pin 200 (see FIG. 6), when in a mounted or operational position (see FIGS. 7 and 8), such that the lynch pin 200 is locked within the receiver pin 126 (see FIG. 2). Similar to the side arm 310, the top arm 330 is integral with the body 234 and includes a radial edge that directs the top arm 330 from the body 234 toward the positive Z direction. The top arm 330 defines a top arm depth D2 which is measured as the distance between the front face 242 and a distal end of the top arm 330. In many cases, the top arm depth D2 is substantially equivalent to the side arm depth D1. Alternatively, the top arm depth D2 may be greater than the side arm depth D1, or vice versa. A top arm length L2 defines the distance measurement of the arm in the X direction. i.e., a distance measurement of the arm taken along the width 286 of the bracket 230. In this instance, the top arm 330 is offset from the Y axis since the top arm 330 extends entirely to the second side surface 282 on the closed side 264, but extends entirely to the first side surface 278 on the open side 262. In other instances, the top arm 330 does not extend entirely to the first side surface 278 or the second side surface 282. In yet other instances, the top arm 330 extends entirely to the second side surface 282, but not entirely to the first side surface 278.

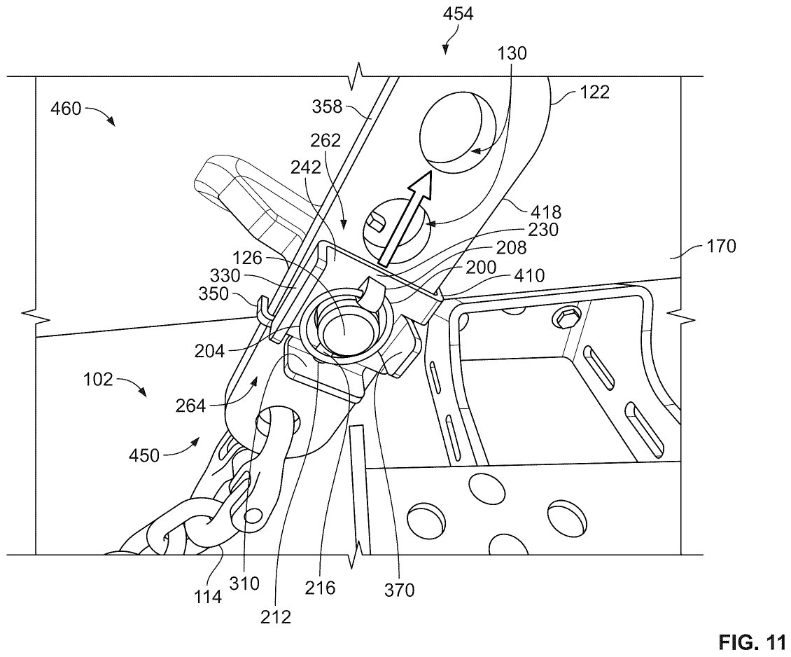

Still referring to FIG. 10, the rear view of the bracket 230 is shown to include a support arm 350 that extends from an upper surface 354 of the top side 274 of the body in a negative Z direction, opposite the top arm 330 and the side arm 310. As will be discussed further below, the support arm 350 is configured to engage with a top surface 358 (see FIG. 11) of the adjustable plate 122 (see FIG. 1) to assist with the alignment between the top side 274 of the bracket 230 and a parallel edge of the adjustable plate 122. Further, this alignment helps maintain that the bracket 230 rotates in correspondence with the adjustable plate 122 during a mounting and/or unmounting process. Similar to each of the aforementioned arms, 310, 330, the support arm 350 is integral with the body 234 and includes a radial edge that directs the support arm 350 from the body 234 toward the negative Z direction. As illustrated, the radial edge of the support arm 350 connects from an elevated portion of the body 234. In this way, the support arm 350 extends above the top arm 330 when the bracket is in an upright position, thereby allowing for the support arm 350 to reach the top surface 358 of the adjustable plate 122.

Still referring to FIG. 10, the support arm 350 defines a support arm depth D3 which is measured as the distance between the rear face 246 and a distal end of the support arm 350. In many cases, the support arm depth D3 is substantially equivalent to the side arm depth D1 and the top arm depth D2. Alternatively, the support arm depth D3 may be greater than or less than either of the side arm depth D1 or the top arm depth D2. A support arm length L3 defines a distance measurement of the support arm 350 in the X direction, i.e., a distance measurement of the arm taken along the width 286 of the bracket 230. As shown in this instance, the support arm length L3 is substantially less than both the side arm length L1 and the top arm length L2. In other cases, the support arm length L3 is greater than either or both of the top arm length L2 or the side arm length L1. As illustrated, both the top arm 330 and the support arm 350 extend from the upper surface 354 to the top side 274 of the bracket 230, thus sharing the width 286 of the bracket 230. However, it should be noted that the support arm 350 may extend from the upper surface 354 in a manner that does not influence the top arm length L2. Conversely, the top arm 330 may extend from the top side 274 in a manner that does not influence the support arm length L3. Although not limiting, for example, the support arm 350 may extend entirely from the rear face 246 of the bracket, and offset from the Z axis in a negative Z direction such that the support arm 350 and the top arm 330 share a common portion of the width 286 of the bracket 230. In other instances, for example, the top arm 330 may extend entirely from the front face 242 of the bracket, and offset from the Z axis in a positive Z direction such that the top arm 330 and the support arm 350 share a common portion of the width 286 of the bracket 230.

Referring back to FIG. 9, the bracket 230 includes a center leg 370 that extends from a lower surface 374 of the body 234 in a positive Z direction. As will be discussed further below, the center leg 370 is configured to be adjacent the distal end 212 of the lynch pin 200 (see FIG. 2), when the forklift is in a mounted position. Similar to the aforementioned arms 310, 330, 350, the center leg 370 includes a radial edge that directs the center leg 370 from the body 234 toward the positive Z direction. The center leg 370 defines a center leg depth D4 which is measured as the distance between the front face 242 and a distal end of the center leg 370. In many cases, the center leg depth D4 is substantially equivalent to the top arm depth D2 and the side arm depth D1. Alternatively, the center leg depth D4 may be greater than either of the side arm depth D1 or the top arm depth D2, or vice versa. A center leg length L4 defines a distance measurement of the center leg 370 in the X direction, i.e., a distance measurement of the leg along the width 286 of the bracket 230. In this instance, the center leg 370 is centered on the Y axis, however, in some instances, the center leg 370 is offset to either the positive X direction or the negative X direction. In other instances, the center leg 370 extends entirely along the width 286 of the bracket 230.

Referring again to FIG. 10, the bracket 230 includes an open side leg 410 and a closed side leg 414. As will be discussed further below, the open and closed side legs 410, 414, similar to the support arm 350, are configured to engage with a bottom surface of the adjustable plate 122 (see FIG. 1) to assist with the alignment between a bottom edge 418, or bottom surface, of the adjustable plate and a bottom side 270 of the bracket 230. Further, this alignment helps maintain that the bracket 230 rotates in correspondence with the adjustable plate 122 during a mounting and/or unmounting process. Both the open and closed side legs 410, 414 share similar thickness and structural features to that of the aforementioned arms 310, 330, 350 and center leg 370. The open and closed side legs 410, 414 extend from the lower surface 374 of the body 234 in a positive Z direction and each include a radial edge that directs the open and closed side legs 410, 414 toward the negative Z direction. In particular, the radial edge directs each of the open and closed side legs 410, 414 by connecting from a protruding portion of the body 234, similar to the radial edge that directs the support arm 350 on the top side 274 of the bracket 230. The open side leg 410 is disposed on the open side 262 of the bracket and is adjacent the first side surface 278. Correspondingly, the closed side leg 414 is disposed on the closed side 264 of the bracket 230 and is adjacent the second side surface 282.

With continued reference to FIG. 10, the open leg 410 and the closed leg 414 define an open leg depth D5 and a closed leg depth D6, respectively. The open and closed side depths D5, D6 are each measured as the distance between the rear face 246 and a distal end of the corresponding open and closed side leg 410, 414, respectively. In many cases, the open leg depth D5 is substantially equivalent to the closed leg depth D6, the side arm depth D1, the top arm depth D2, and the support arm depth D3. Alternatively, the open leg depth D5 may be different than any of the closed leg depth D6, the side arm depth D1, the top arm depth D2, and the support arm depth D3. The open side leg 410 and the closed side leg 414 define an open leg length L5 and a closed leg length L6, respectively, that is measured as a distance in the X direction.

As illustrated, the open leg length L5 is greater than the closed leg length L6; however, in some cases, the closed leg length L6 may be greater, or the open leg length L5 is substantially equivalent to the closed leg length L6. In other cases, each of the open leg length L5 and the closed leg length L6 are modified as necessary to properly engage with the bottom edge 418 (see FIG. 11-13) or portion of the adjustable plate 122 (see FIG. 1) to which it couples thereon. As illustrated, each of the open side leg 410, closed side leg 414, and the center leg 370 extends from the lower surface 374 of the bracket 230, thus, sharing the width 286 of the bracket 230. However, similar to the top arm 330 and the support arm 350, the open and closed side legs 410, 414, may extend from the bottom side 270 in a manner that does not influence the center leg length L4. Conversely, the center leg 370 may extend from the bottom side 270 in a manner that does not influence the support arm length L3. For example, the center leg 370 may extend entirely from the front face 242 of the bracket 230, and offset from the Z axis in a positive Z direction such that the center leg 370 shares a common portion of the width 286 of the bracket 230 with either of the open side leg 410 or closed side leg 414. In other instances, for example, the open and closed side legs 410, 414, may extend entirely from the rear face 246 of the bracket, and offset from the Z axis in a negative Z direction such that the center leg 370 shares a common portion of the width 286 of the bracket 230.

Although the bracket 230, as illustrated in FIGS. 9 and 10, is shown as a right side component for ease of description, it should be understood that a corresponding bracket for the opposite side, or left side of a forklift mount, is constructed by reflecting or inverting the illustrated features across the Y axis. Accordingly, the structural and functional elements shown herein are equally applicable to a laterally opposed bracket, which may constitute a mirror-image counterpart of the bracket depicted. The corresponding left side bracket is intended to be included within the subject matter of the present disclosure.

Referring now to FIG. 11, the bracket 230, now shown as a left side bracket, is coupled to the adjustable plate 122. To properly couple the bracket 230 to the transport chain 102, the bracket 230 should be fitted around the receiver pin 126 with the closed side 264 of the bracket 230 oriented on a chain side end 450 of the adjustable plate 122, i.e., side of the adjustable plate that directly couples to the chain portion. Correspondingly, in this configuration, the open side 262 is oriented toward a forklift end 454, opposite the chain side end 450 of the adjustable plate 122. In this way, the top arm 330 aligns generally parallel with the top surface 358 of the adjustable plate 122, and the center leg 370 aligns generally parallel with the bottom edge 418. The support arm 350, in conjunction with the open and closed side legs 410, 414 (see FIG. 10), is configured to secure the bracket 230 onto the front surface of the adjustable plate 122 and in a fixed position relative to the adjustable plate 122. Particularly, the support arm 350 extends above the adjustable plate 122 and contacts the upper surface of the adjustable plate 122, and each of the open and closed side legs, 410, 414 (see FIG. 10), extend below the adjustable plate 122 and contact the bottom edge 418 and lower surface thereof.

The top arm 330, the side arm 310, and the center leg 370 each function to retain the lynch pin 200 within the receiver pin 126. As described above, the receiver pin 126 is integral with the forklift 170 and is configured to provide a rigid support point for transferring load from the transport chain 102 to a truck. As shown in FIG. 11, the transport chain 102 is in an adjustment position 460. In the adjustment position 460, the lynch pin 200 can be easily removed from the receiver pin 126 to allow for necessary adjustments to the length 134 (see FIG. 1) of the transport chain 102. As illustrated, the lynch pin 200 generally extends in a vertical direction, and, in many cases, the receiver pin 126 can be rotated such that the through holes 152 (see FIG. 2) extend in a substantially vertical direction. By doing this, the shaft 216 of the lynch pin 200 can be slotted through an aperture of the plurality of apertures 130 (see FIG. 2) so the head 208 of the lynch pin 200 is disposed above the distal end 212. When adjusting the transport chain 102 as illustrated, the transport chain 102 is disengaged from the truck 176 (see FIG. 4), thus, increasing slack in the transport chain 102. As a result, the bracket 230 correspondingly rotates with the adjustable plate 122 about the receiver pin 126 such that the chain side end 450 is oriented downward to a ground surface and the forklift end 454 is oriented upward. In this configuration, the lynch pin 200 can be readily removed from the receiver pin 126 to permit any necessary adjustment to the length 134 (see FIG. 1) of the transport chain 102. It should be noted, however, that the orientation of the receiver pin 126 is preferably maintained in a fixed position to ensure proper removal and retention of the lynch pin 200 as required. The distal end 212 of the lynch pin 200 is typically oriented adjacent to, or in contact with the side arm 310 of the bracket 230 when in the adjustment position 460. Correspondingly, the open side 262 is positioned opposite the side arm 310, which allows for full removal of the lynch pin 200. In the adjustment position 460, the bracket 230 facilitates insertion and/or removal of the lynch pin 200 during mounting and unmounting as a result of the bracket rotation relative the receiver pin 126, and thus, the lynch pin 200.

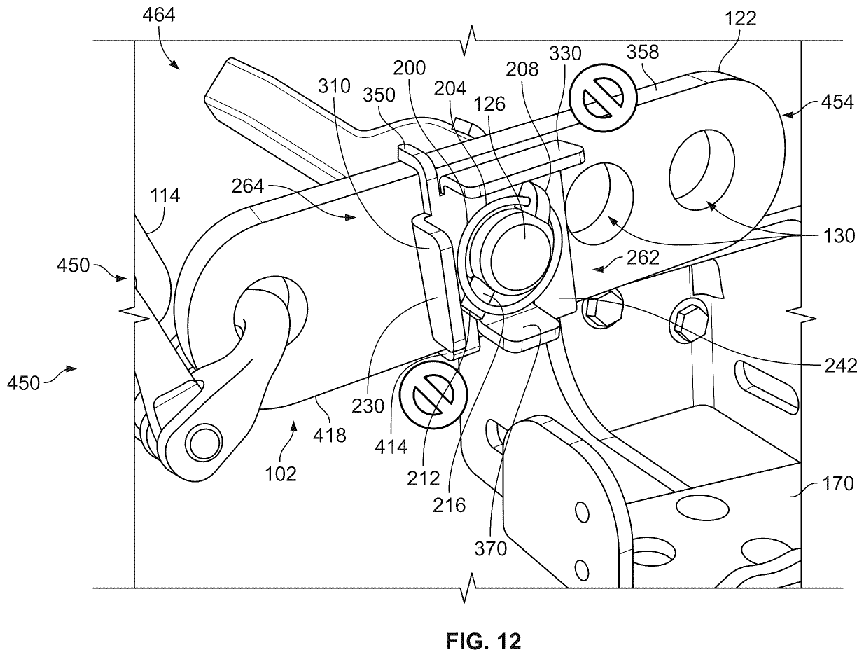

Referring now to FIG. 12, the transport chain 102 is shown in a working position 464. In the working position 464, the bracket 230 is configured to retain the lynch pin 200 through the receiver pin 126 as the forklift 170 is used for routine operation on a job site. Particularly, the shackle 118 (see FIG. 1) of the transport chain 102 is attached to a separate component (not shown) of the forklift 170 when the transport chain 102 is not required for use. Here, the adjustable plate 122 rests in a generally horizontal position. Resultantly, in the working position 464, the top arm 330 restrains any vertical sliding movement of the lynch pin 200 within the receiver pin 126, namely by positioning the top arm 330 adjacent to, or in contact with, the head 208 of the lynch pin 200. In this orientation, both of the side arm 310 and the center leg 370 are adjacent to the distal end 212 of the lynch pin 200. Although the transport chain 102 is not actively securing the forklift 170 to a truck trailer, the bracket 230 nevertheless functions to ensure that the lynch pin 200 maintains the adjustable plate 122 to be secured around the receiver pin 126 by positioning the top arm 330 above the head 208 of the lynch pin 200.

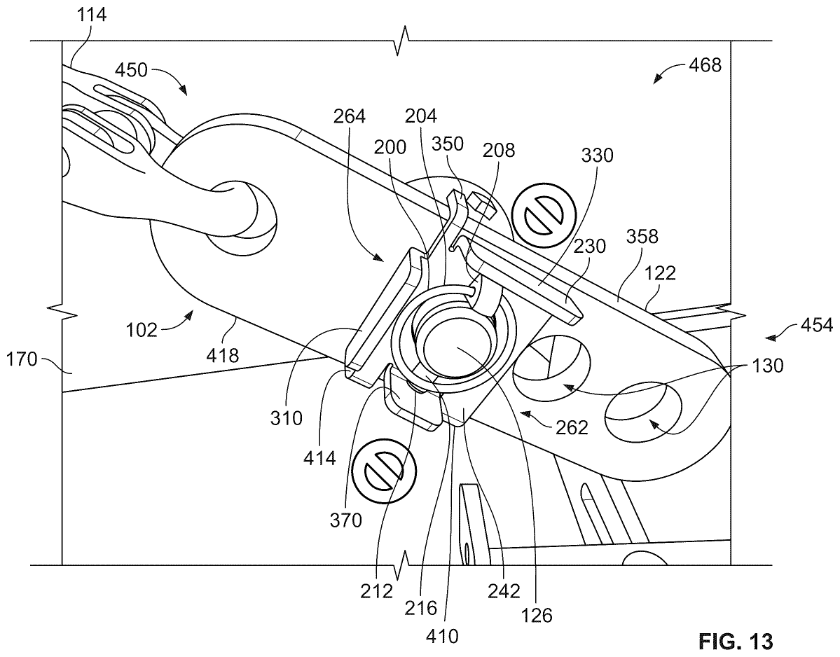

Referring now to FIG. 13, the transport chain 102 is shown in a travel position 468. In the travel position 468, the bracket 230 is configured to retain the lynch pin 200 through the receiver pin 126 as the forklift 170 is mounted on the rear of a truck during transportation. Particularly, the transport chain 102 is attached to an anchor point (not shown) of the truck, and all slack from the transport chain 102 is removed. To get into this position, the adjustable plate 122 rotates about the receiver pin 126 such that the chain side end 450 of the adjustable plate 122 is disposed above the forklift end 454. In this configuration, the bracket 230 correspondingly rotates with the adjustable plate 122 thereby positioning the top arm 330 of bracket 230 directly above the head 208 of the lynch pin 200, and the center leg 370 of the bracket 230 directly beneath, or in contact with the distal end 212 of the lynch pin 200. When the transport chain 102 is tensioned in the travel position 468, the top arm 330, the side arm 310, and the center leg 370 operate cooperatively to restrain vertical sliding movement of the lynch pin 200 within the receiver pin 126. For example, in circumstances when the retaining ring 204 breaks apart from the lynch pin 200, the top arm 330, the side arm 310, and the center leg 370 can ensure the lynch pin 200 is still held in place within the receiver pin 126. It should be understood that, to provide the aforementioned positions, the bracket 230 is configured to rotate relative to the rigid receiver pin 126 such that any of the arms may be disposed above the head 208 of the lynch pin 200, or such that no arms are disposed above the head 208 of the lynch pin 200.

In some embodiments, the bracket 230 is integrally formed with the adjustable plate 122 such that the adjustable plate 122 includes the protruding arms and legs that perform the functions of the bracket 230. In this configuration, the adjustable plate 122 defines a unitary body that includes one or more features providing the function of the top arm 330, side arm 310, and the center leg 370. Particularly, features configured to be disposed above the head 208 of the lynch pin 200 and/or configured to contact or underlie the distal end 212 of the lynch pin 200 when the adjustable plate 122 is in varying positions about the receiver pin 126. The integral construction may increase structural rigidity under vibration and impact encountered during transport.

In some embodiments, the bracket 230 may include any suitable number and arrangement of arms and/or legs disposed on one or more sides (e.g., the top side 274, bottom side 270, open side 262, and/or closed side 264) to sufficiently retain the lynch pin 200 within the receiver pin 126 and to couple the bracket 230 to the adjustable plate 122. For example, certain instances may omit one or more support features, such as the support arm 350, the open side leg 410, and/or the closed side leg 414, where positional stability and plate engagement are obtained sufficiently through the remaining features. In other instances, the level of retainment may be modified based on the relative configuration; for example, there may be more or fewer retainment arms, such as the top arm 330, the side arm 310, and/or the center leg 370. Duplicated, segmented, or shortened variations thereof may be incorporated to secure the head 208 and/or distal end 212 of the lynch pin 200. Additional arms or legs may be oriented with different depths, lengths, or offsets in X, Y, and/or Z directions (see FIGS. 9 and 10) to accommodate varying adjustable plate 122 geometries, or different diameters of the receiver pin 126, while still providing engagement that maintains alignment of the bracket 230 with the adjustable plate 122 and restrains vertical sliding movement of the lynch pin 200 during working and/or travel positions 464, 468 (see FIGS. 12 and 13).

In other embodiments of the present disclosure, the bracket 230 can be configured for bilateral use on either a left side or a right side of the truck trailer. In one instance, for example, the bracket 230 has bilateral symmetry about the Y axis (see FIG. 9) (i.e., mirror symmetry across a vertical midline across the opening 238), such that the same bracket 230 can be installed on either side of the truck trailer. In this particular instance, one or more of the asymmetrical features may be omitted such as the side arm 310. Further, the open side leg 410 and the closed side leg 414 may be positioned to be substantially identical, and the top arm 330 and the center leg 370 may be centered on the Y axis (see FIG. 9).

In further variations, the support arm 350 may be omitted or replaced with dual support arms/tabs positioned symmetrically relative to the Y axis (see FIG. 9), which are each configured to engage the upper surface 354 of the adjustable plate 122. Such symmetry allows the bracket 230 to couple to the adjustable plate 122 while still restraining vertical sliding movement for the lynch pin 200 when in the working position 464 (see FIG. 12) and the travel position 468.

In yet other embodiments, the lynch pin 200 may be replaced with any suitable industrial fastening pin that provides equivalent retention of a shaft within the through holes 152 (see FIG. 2) of the receiver pin 126. For example, alternatives include a cotter pin, an R-clip or hairpin cotter, a wire-lock pin, a handle pin, a clevis pin, or a quick-release pin. In such embodiments, the bracket 230 and the adjustable plate 122 constrain the selected fastening pin so that a head, handle, or retainer portion is disposed adjacent the top arm 330, and a distal portion is supported by the center leg 370, or equivalent retainment feature. The alternative fastening pins may include integral springs, wire loops, detents, or secondary retainers that engage the receiver pin 126 to resist vibration-induced loosening, and may be inserted and removed without tools when in the adjustment position 460 (see FIG. 11).

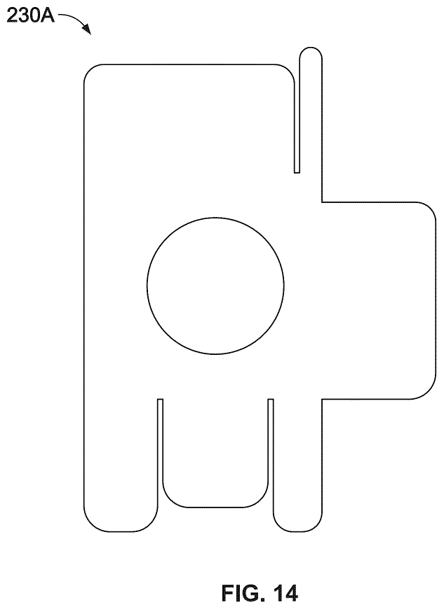

Referring now to FIG. 14, a front outline of a plate structure 230A that forms the bracket 230 of FIGS. 9 and 10, is shown. As discussed above in connection with FIG. 9, the side arm 310, the top arm 330, the support arm 350, the center leg 370, the open side leg 410, and the closed side leg 414 can all be formed by bending a plate structure having a predetermined outline, such as the plate structure 230A shown in FIG. 14. It should be understood that any of the foregoing embodiments of the bracket 230 may be formed by bending a plate structure having a corresponding pre-configured shape.

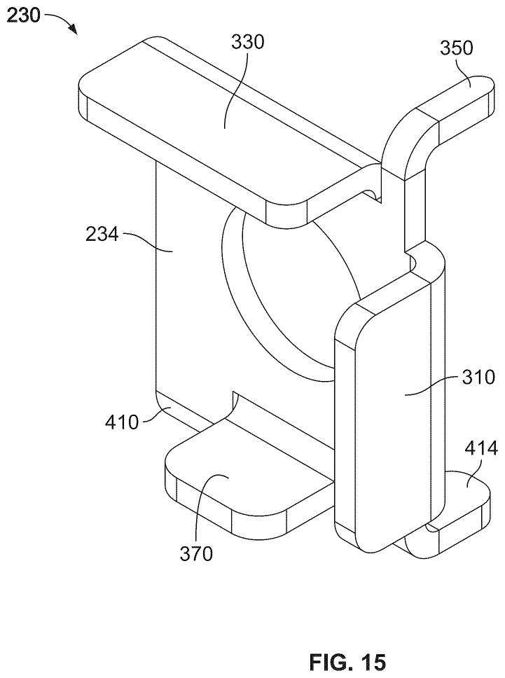

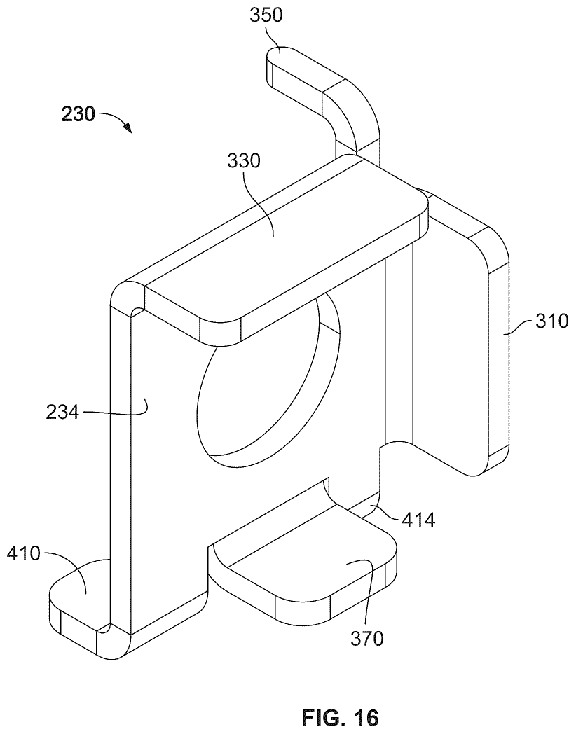

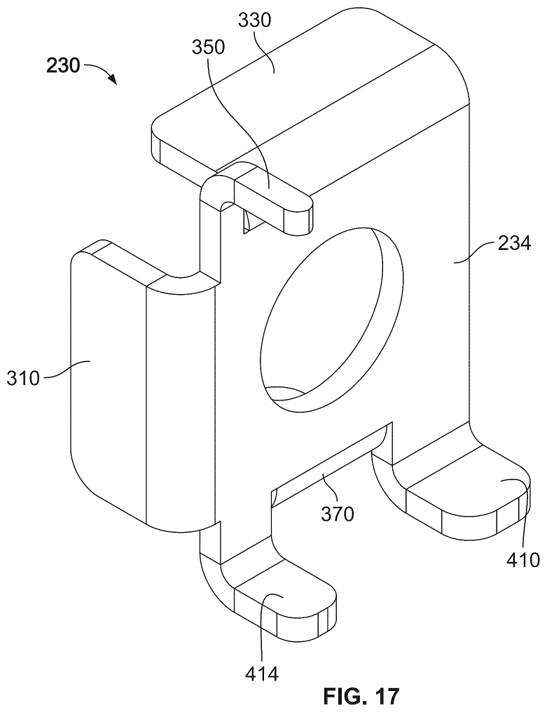

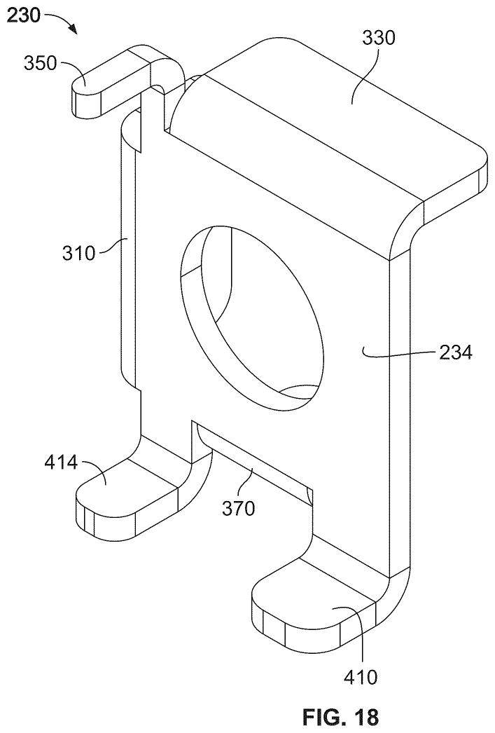

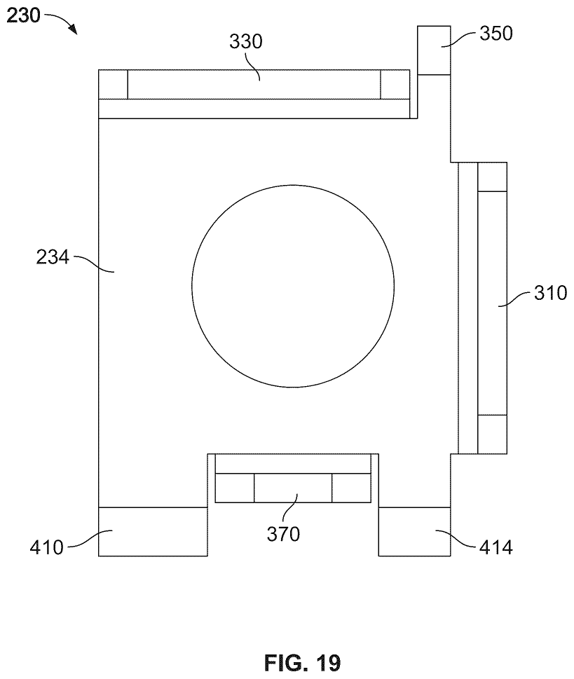

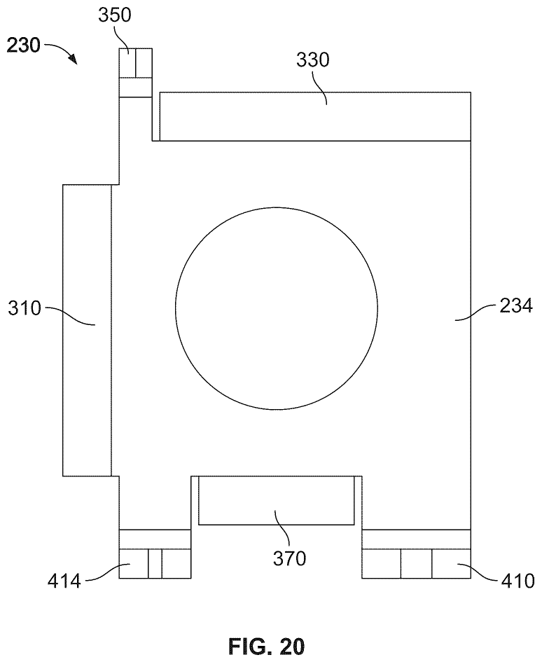

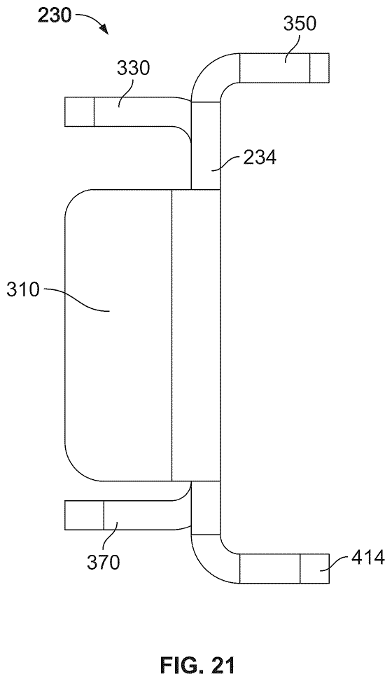

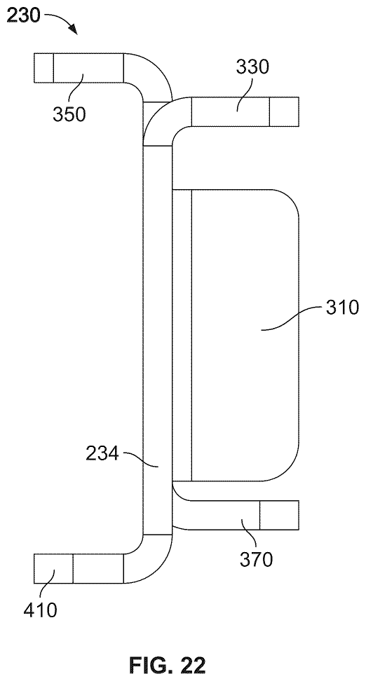

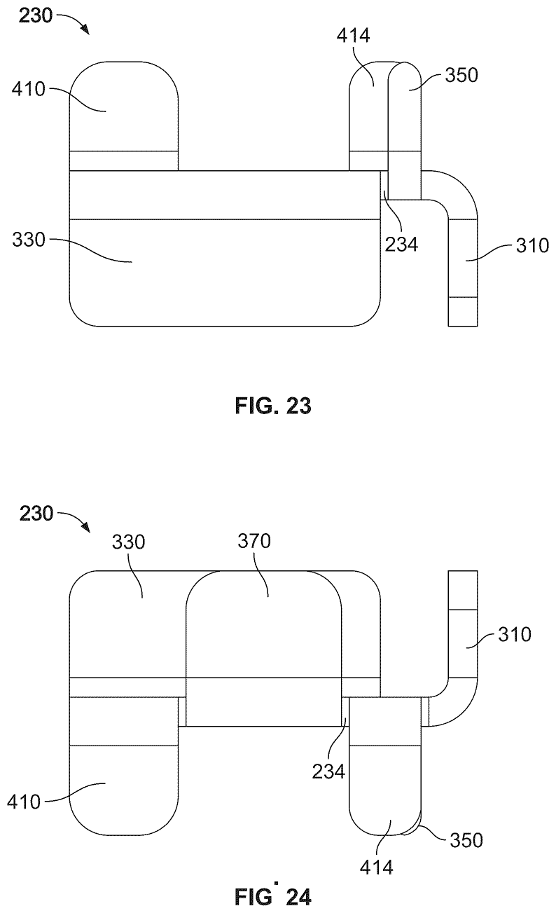

Referring now to FIGS. 15-18, various isometric views of the bracket 230 of FIG. 9 are shown. Referring to FIGS. 19-24, various orthogonal views of the bracket 230 of FIG. 9 are shown.

It will be appreciated by those skilled in the art that while the embodiments of the present disclosure have been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use and to teach the best mode of carrying out same. The exclusive rights to all modifications which come within the scope of the appended claims are reserved.

What is claimed is:

1. A mounting system for mounting a forklift to a transport vehicle, the transport vehicle including a first anchoring point and the forklift including a second anchoring point, the mounting system comprising:
a chain assembly that is configured to extend between the first anchoring point and the second anchoring point, the second anchoring point being an anchor pin that extends from the forklift,
wherein the chain assembly includes an adjustable plate having a first aperture that receives the anchor pin of the forklift; and
a bracket that couples with the adjustable plate and is configured to receive the anchor pin through an opening of the bracket,
wherein a retainment pin extends through a second aperture of the anchor pin, the retainment pin being capable of retaining the adjustable plate around the anchor pin, and
wherein the bracket is configured to retain the retainment pin through the second aperture.

2. The mounting system of claim 1, wherein the bracket is configured to allow for removal of the retainment pin when the chain assembly is in an adjustment position.

3. The mounting system of claim 2, wherein the bracket rotates about the anchor pin when the chain assembly is moved from the adjustment position to a travel position.

4. The mounting system of claim 3, wherein the first plurality of tabs is configured to retain the retainment pin when the chain assembly is in the travel position.

5. The mounting system of claim 1, wherein the bracket defines a body that includes a front face and a rear face opposite the front face, and
wherein the bracket includes a first plurality of tabs that extend from the body in a first direction.

6. The mounting system of claim 5, wherein the bracket includes a second plurality of tabs that extends from the body in a second direction, and
wherein the first direction and the second direction are perpendicular with respect to the front face and the rear face.

7. The mounting system of claim 6, wherein the second plurality of tabs is configured to couple with the adjustable plate.

8. A bracket for retaining a retainment pin, the bracket comprising:
a body that defines a front face, a rear face opposite the front face, and a central opening that is configured to receive an anchor pin therethrough;
a plurality of protruding tabs including:
a first tab that extends from a bottom side of the bracket in a first direction,
a second tab that extends from a top side of the bracket in a second direction opposite the first direction,
a third tab that extends from a top side of the bracket in the first direction, and
a fourth tab that extends from a lateral side of bracket in the first direction, the lateral side of the bracket defined between the top side and the bottom side,
wherein the fourth tab is configured to retain a retainment pin that is configured to extend through an aperture of the anchor pin, and
wherein the second tab is configured to be coupled with a plate that is configured to receive the anchor pin.

9. The mounting bracket of claim 8, wherein the first tab is configured to retain the retainment pin, and
wherein the third tab is configured to retain the retainment pin.

10. The mounting bracket of claim 8, wherein the plurality of tabs further includes a fifth tab and a sixth tab, and
wherein the fifth tab and the sixth tab each extend from the bottom side of the bracket in the second direction.

11. The mounting bracket of claim 10, wherein the first tab is disposed between the fifth tab and the sixth tab.

12. The mounting bracket of claim 11, wherein the fifth tab and the sixth tab are each configured to be coupled with the plate.

13. The mounting bracket of claim 8, wherein the bracket is configured to allow for removal of the retainment pin when the plate is in a first position.

14. The mounting bracket of claim 13, wherein the fourth tab is configured to be disposed adjacent to a distal end of the retainment pin when the plate is in the first position,
wherein the second tab is configured to be disposed adjacent to a head of the retainment pin when the plate is in a second position, and
wherein the head of the retainment pin is configured to be disposed opposite the distal end.

15. A method of mounting a forklift to a transport vehicle, the method comprising:
connecting a chain assembly between a first anchor point on the transport vehicle and a second anchor point on the forklift, the second anchor point being an anchor pin, wherein the chain assembly includes an adjustable plate having an aperture;
configuring the aperture of the adjustable plate around the anchor pin, wherein the adjustable plate is secured around the anchor pin with a retainment pin that extends through a distal end of the anchor pin; and
configuring a bracket around the anchor pin,
wherein the bracket includes a first plurality of tabs that are each configured to be coupled with the adjustable plate, and
wherein the bracket includes a second plurality of tabs that are each configured to retain the retainment pin within the anchor pin when the chain assembly is in a travel configuration.

16. The method of claim 15, wherein the retainment pin is capable of being removed from the anchor pin when the chain assembly is in an adjustment configuration.

17. The method of claim 15, wherein the bracket is disposed between the adjustable plate and the retainment pin.

18. The method of claim 16, wherein the bracket and the adjustable plate are capable of being rotated about the anchor pin.

19. The method of claim 15, wherein the first plurality of tabs extends from a body of the bracket in a first direction, and
wherein the second plurality of tabs extends from the body of the bracket in a second direction, opposite the first direction.

20. The method of claim 15, wherein the bracket is a unitary member.
